(19) United States
(12) Patent Application Publication
(10) Pub. No.: US 2023/0361338 A1
(43) Pub. Date: Nov. 9, 2023

(54) SOLID-STATE BATTERY AND METHOD OF MANUFACTURING SOLID-STATE BATTERY UTILIZING SPRAY PYROLYSIS

(71) Applicants: Samsung Electronics Co., Ltd., Suwon-si (KR); Massachusetts Institute of Technology, Cambridge, MA (US)

(72) Inventors: Andrea Maurano, Boston, MA (US); Jesse John Hinricher, Pipestone, MN (US); So Yeon Kim, Cambridge, MA (US); Jennifer Lilia Marguerite Rupp, Starnberg (DE); Ju Li, Weston, MA (US); Yuntong Zhu, Kirkland, WA (US); Hyunwon Chu, Cambridge, MA (US); Zachary David Hood, Bolingbrook, IL (US); Won Seok Chang, Seoul (KR); Kai Pei, Hohhot (CN); Yimeng Huang, Waltham, MA (US); Srinath Chakravarthy, Glastonbury, CT (US); Ziqiang Wang, Cambridge, MA (US)

(21) Appl. No.: 17/745,776

(22) Filed: May 16, 2022

Related U.S. Application Data
(60) Provisional application No. 63/337,984, filed on May 3, 2022.

(51) Int. Cl. H01M 10/0562; H01M 4/04; H01M 10/0565; H01M 10/052

(52) U.S. Cl. CPC H01M 10/0562; H01M 4/0407; H01M 10/0565; H01M 10/052; H01M 2300/0071; H01M 2300/0082; H01M 2300/0085

(57) ABSTRACT

An electrochemical cell and a method of manufacturing the electrochemical cell are provided. The method includes: spraying a precursor solution on an anode, the precursor solution including a metal salt dissolved in a solvent and the anode being at a temperature of 250° C. or greater; reacting the metal salt on the anode to form a buffer layer; and attaching a solid-state electrolyte to the buffer layer.

### CROSS-REFERENCE TO RELATED APPLICATION

The present application claims priority to and the benefit of U.S. Provisional Application No. 63/337,984, filed on May 3, 2022, the entire content of which is incorporated herein by reference.

### FIELD

The present disclosure relates generally to a solid-state battery and a method of manufacturing the solid-state battery, in particular, a method of depositing an electron-ion insulator layer on a metal anode utilizing spray pyrolysis.

### BACKGROUND

Conventional batteries with a liquid electrolyte may be prone to problems such as leakage and ignition of the electrolyte. In order to improve safety, solid-state batteries including a solid-state electrolyte have gained attention as the next generation batteries. However, there remains a need to resolve the issue of detachment of the solid-state electrolyte from the anode in solid-state batteries.

The above information disclosed in this Background section is only for enhancement of understanding of the background of the invention and therefore it may contain information that does not constitute prior art.

### SUMMARY

According to one or more embodiments of the present disclosure, a method of manufacturing an electrochemical cell includes: spraying a precursor solution on an anode, the precursor solution including a metal salt dissolved in a solvent and the anode being at a temperature of 250° C. or greater; reacting the metal salt on the anode to form a buffer layer; and attaching a solid-state electrolyte to the buffer layer.

In some embodiments, the reacting of the metal salt includes decomposing the metal salt and/or reacting the metal salt with a reactive gas.

In some embodiments, the anode is at a temperature of 280° C. to 330° C.

In some embodiments, the method further includes providing a set volume of the precursor solution to an atomizer.

In some embodiments, the buffer layer has a porosity of 40% to 98%, based on a total volume of the buffer layer.

In some embodiments, the anode has a first porosity, the buffer layer has a second porosity, and a ratio between the second porosity and the first porosity is 1.2:1 to 0.5:1.

In some embodiments, the ratio between the second porosity and the first porosity is 1.05:1 to 1.2:1.

In some embodiments, the buffer layer is to expose 50% or greater of pores adjacent to the buffer layer in the anode, based on a total number of pores adjacent to the buffer layer in the anode.

In some embodiments, the buffer layer is about 5 nm to 500 nm in thickness.

In some embodiments, the buffer layer includes a material represented by Formula (1):

MₘNₙZ_{z}HₕXₓ (1)
wherein in Formula (1),
M is Na, K, Rb, Cs, Al, a metal of Group 2 or Group 3, or a combination thereof;
m is 1, 2, 3, or 4;
X is at least one halogen;
x is 0, 1, 2, or 6;
Z is 0, S, or a combination thereof;
z is 0, 1, 2, 3, or 4;
N represents nitrogen;
n is 0, 1, or 2;
H represents hydrogen; and
h is 0, 1, 2, or 3,
provided that x+z+n+h is at least 1.

In some embodiments, Z is O and z is 1, 2, 3, or 4.

In some embodiments, the metal salt includes a nitrate, a hydroxide, a sulfate, an oxalate, an acetate, a phosphate, a carbonate, a hydrozoic acid, a chloranilic acid, a trifuloromethane sulfonate, an isopropoxide, and/or an acetylacetonate salt of a metal.

In some embodiments, the metal salt of the precursor solution includes a metal and an anion group including a non-metal element, and the buffer layer includes the metal and the non-metal element, and the non-metal element is about 0.01 atomic % (at %) to about 65 at % in amount based on a total number of atoms in the buffer layer.

In some embodiments, the non-metal element is about 0.1 at % to about 5 at % in amount based on the total number of atoms in the buffer layer.

In some embodiments, the non-metal element includes N, F, Cl, I, Br, S, O, C, and/or P.

In some embodiments, the buffer layer includes La₂O₃ and about 1 atomic % (at %) to about 5 at % of N.

According to one or more embodiments of the present disclosure, an electrochemical cell includes an anode having a first porosity, a buffer layer on the anode and having a second porosity, and a solid-state electrolyte on the buffer layer, wherein a ratio between the second porosity and the first porosity is 1.2:1 to 0.5:1.

In some embodiments, the ratio between the second porosity and the first porosity is 1.05:1 to 1.2:1.

In some embodiments, the buffer layer includes a material represented by Formula (1):

MₘNₙZ_{z}HₕXₓ (1)
wherein in Formula 1,
M is Na, K, Rb, Cs, Al, a metal of Group 2 or Group 3, or a combination thereof;
M is 1, 2, 3, or 4;
X is at least one halogen;
x is 0, 1, 2, or 6;
Z is 0, S, or a combination thereof;
z is 0, 1, 2, 3, or 4;
N represents nitrogen;
n is 0, 1, or 2;
H represents hydrogen; and
h is 0, 1, 2, or 3,
provided that x+z+n+h is at least 1.

In some embodiments, Z is 0 and z is 1, 2, 3, or 4.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable device.

### BRIEF DESCRIPTION OF THE DRAWINGS

These and other features and enhancements of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIG. 1 is a schematic illustration of an electrochemical cell according to an embodiment of the present disclosure.

FIG. 2 is a schematic illustration of a porous anode and a buffer layer according to an embodiment of the present disclosure.

FIG. 3 is a schematic illustration of a porous anode solid-state electrolyte assembly with a buffer layer therebetween according to embodiments of the present disclosure.

FIG. 4A is a flow chart illustrating a method of depositing the buffer layer utilizing spray pyrolysis.

FIG. 4B is a schematic illustration of depositing a buffer layer utilizing spray pyrolysis.

FIG. 5 is a schematic illustration of a process of forming a solid-state battery according to embodiments of the present disclosure.

FIGS. 6A-6C are SEM images showing a TiN porous anode, and the TiN porous anode coated with 0.5 mL Li azide precursor and with 1.0 mL Li azide precursor, respectively.

FIGS. 7A-7F are SEM images at 5 k magnification showing a carbon based porous substrate, and the substrate coated with 1 mL, 2 mL, 3 mL, 4 mL and 5 mL of a precursor solution, respectively.

FIGS. 8A-8F are SEM images at 25 k magnification of the same set of samples as FIGS. 7A-7F.

FIG. 9 is a Raman spectrum of the La₂O₃ buffer layer coated on the carbon based substrate, the carbon based substrate, commercial La₂O₃ powder, and the La(NO₃)₃ precursor.

FIG. 10A shows an XPS spectrum of a buffer layer surface as deposited; FIG. 10B shows the XPS spectrum of the buffer layer surface after the buffer layer has been etched for 300 s; and FIG. 10C shows the overall depth profile of O, La, C and N in the buffer layer.

FIGS. 11A-11B show the change in impedance as a function of the number of charging-discharging cycles in the cells of Example 3 and Comparative Example 1 respectively.

FIGS. 12A-12B are SEM images of a cross-sectional view of the cells of Example 3 and Comparative Example 1 after 50 cycles of charging and discharging, respectively.

### DETAILED DESCRIPTION

Hereinafter, example embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof may not be repeated.

In the drawings, the relative sizes of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein. The term “diameter” as used herein may refer to the diameter of a circular or spherical shape, or the equivalent diameter of a non-circular or non-spherical shape.

A related art solid-state battery includes a cathode, an anode, and a solid-state electrolyte (SSE) between the cathode and the anode and in direct contact with the cathode and the anode. As the battery goes through charging and discharging cycles, volume change may happen inside the battery, which may affect the mechanical integrity of the SSE and its interfaces. Furthermore, volume changes during cycling may reduce the contact between the SSE and the anode, and lead to separation of the SSE from the anode. In addition, during cycling, metal ions tend to chemically reduce and thus precipitate at the interface between the SSE and the anode. The precipitated metal then leads to a loss of contact between the SSE and the anode. The reduction or loss of contact is undesirable or even detrimental for the battery operation and is one of the main causes of battery failure. In extreme cases, such reduction or loss of contact can lead to partial or full detachment of the anode from the SSE, creating an open circuit system.

Metal anodes with porous structures are better in accommodating the volume change. However, cation reduction and metal precipitation at the interface between the SSE and the metal anode during charging and discharging cycles may form a barrier layer between the SSE and the metal anode and may still lead to the detachment between the two. To solve this problem, a buffer layer may be additionally included between the SSE and the metal anode to reduce or prevent cation reduction and metal precipitation at the interface between the SSE and the metal anode.

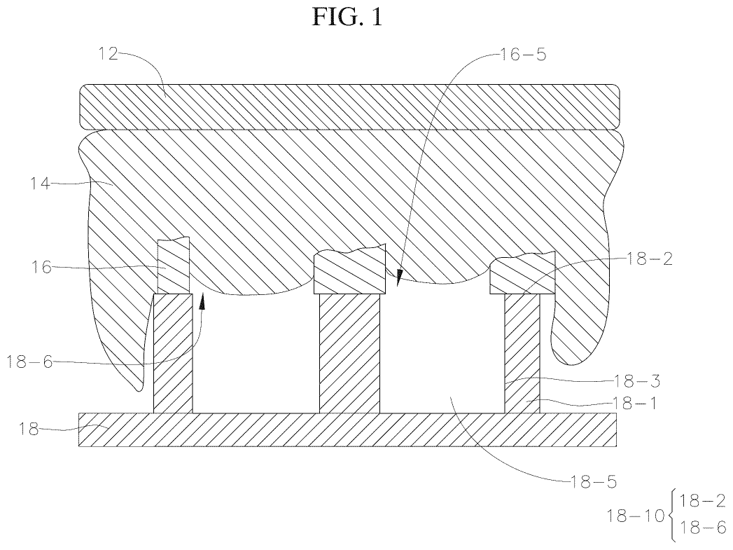

FIG. 1 is a schematic illustration of an electrochemical cell, such as a solid-state battery, according to an embodiment of the present disclosure. Referring to FIG. 1, the electrochemical cell includes a cathode (also referred to as positive electrode) 12, an anode (also referred to as negative electrode) 18, a solid-state electrolyte (SSE) 14 between the cathode 12 and the anode 18, and a buffer layer 16 between the anode 18 and the SSE 14. The cathode 12 may include a positive active material layer including a positive active material on a current collector. The current collector may include a suitable material, such as aluminum. The cathode 12 may be prepared by any suitable method, such as screen printing, slurry casting, or powder compression of the positive active material on the current collector. However, the method of preparing the cathode is not limited thereto, and any suitable method may be utilized.

The positive active material may include any suitable material, such as a lithium transition metal oxide, a transition metal sulfide, or a combination thereof. Example positive active materials may include one or more compounds represented by the following formulas: LiₐA_{1-b}R_{b}D₂ (0.90≤a≤1.8 and 0≤b≤0.5); LiₐE_{1-b}R_{b}O_{2-c}D_{c} (0.90≤a≤1.8, 0≤b≤0.5 and 0≤c≤0.05); LiE_{2-b}R_{b}O_{4-c}D_{c} (0≤b≤0.5, 0≤c≤0.05); LiₐNi_{1-b-c}Co_{b}R_{c}D_{α} (0.90≤a≤1.8, 0≤b≤0.5, 0≤c≤0.05 and 0<α≤2); LiₐNi_{1-b-c}Co_{b}R_{c}O₂₋ₐZ_{α} (0.90≤a≤1.8, 0≤b≤0.5, 0≤c≤0.05 and 0<α<2); LiₐNi_{1-b-c}Co_{b}R_{c}O₂₋ₐZ₂ (0.90≤a≤1.8, 0≤b≤0.5, 0≤c≤0.05 and 0<α<2); LiₐNi_{1-b-c}Mn_{b}R_{c}D_{α} (0.90≤a≤1.8, 0≤b≤0.5, 0≤c≤0.05 and 0<α≤2); LiₐNi_{1-b-c}Mn_{b}R_{c}O_{2-α}Z_{α} (0.90≤a≤1.8, 0≤b≤0.5, 0≤c≤0.05 and 0<α<2); LiₐNi_{1-b-c}Mn_{b}R_{c}O_{2-α}Z₂ (0.90≤a≤1.8, 0≤b≤0.5, 0≤c≤0.05 and 0<α<2); LiₐNi_{b}E_{c}G_{d}O₂ (0.90≤a≤1.8, 0≤b≤0.9, 0≤c≤0.5 and 0.001≤d≤0.1); LiₐNi_{b}Co_{c}Mn_{d}GₑO₂ (0.90≤a≤1.8, 0≤b≤0.9, 0≤c≤0.5, 0≤d≤0.5 and 0.001≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMnG_{b}O₂ (0.90≤a≤1.8 and 0.001≤b≤0.1); LiₐMn₂G_{b}O₄ (0.90≤a≤1.8 and 0.001≤b≤0.1); QO₂; QS₂; LiQS₂; V₂O₅; LiV₂O₅; LiTO₂; LiNiVO₄; Li_{(3-f)}J₂(PO₄)₃ (0≤f≤2); Li_{(3-f)}Fe₂(PO₄)₃ (0≤f≤2); and LiFePO₄.

In the above chemical formulas, A includes, but is not limited to, Ni, Co, Mn, or a combination thereof; R includes, but is not limited to Al, Ni, Co, Mn, Cr, Fe, Mg, Sr, V, a rare earth element, or a combination thereof; D includes, but is not limited to, O, F, S, P, or a combination thereof; E includes, but is not limited to, Co, Mn, or a combination thereof; Z includes, but is not limited to, F, S, P, or a combination thereof; G includes, but is not limited to, Al, Cr, Mn, Fe, Mg, La, Ce, Sr, V, or a combination thereof; Q includes, but is not limited to, Ti, Mo, Mn, or a combination thereof; T includes, but is not limited to, Cr, V, Fe, Sc, Y, or a combination thereof; and J includes, but is not limited to, V, Cr, Mn, Co, Ni, Cu, or a combination thereof.

The anode 18 may have a porous structure including cell walls 18-1 formed of a negative active material and pores 18-5 surrounded by the cell walls 18-1. The cell walls 18-1 may have an outer surface 18-2 facing the cathode 12, and an inner surface 18-3 defining the pores 18-5. The pores 18-5 may include an opening 18-6 surrounded by the outer surface 18-2 of the cell walls 18-1. The outer surface 18-2 of the walls and the opening 18-6 of the pores together forms the outer surface 18-10 of the porous anode 18.

The negative active material may include a metal, a transition metal nitride, or a combination thereof. Examples of suitable materials for forming the porous anode 18 may include gold (Au), copper (Cu), nickel (Ni), aluminum (Al), silver (Ag), titanium nitride (TiN), gallium nitride (GaN), molybdenum nitride (MoN), or a combination thereof.

In some embodiments, the anode 18 may have a nanostructure. The term “nanostructure” as used herein may refer to a material having a nanofiber structure, a nanorod structure, a nanowire structure, or a nanotube structure, or a nanobody, wherein at least one of the dimensions, i.e., a length, a diameter, or a width of the material may be nano-sized, that is, has a nanometer scale dimension. In some embodiments, the anode 18 may have cell walls 18-1 in the form of ordered nanostructures of the metal, the transition metal nitride, or a combination thereof. In some embodiments, the metal, the transition metal nitride, or a combination thereof may have a nanostructure in the form of nanotubes.

The anode 18 may have a porosity of 50% to 95%, 55% to 80%, 60% to 75%, 62% to 72%, or 65% to 70%, based on a total volume of the anode. The porosity may be determined by any suitable method, such as scanning electron microscopy. Additional details may be determined by one of skill in the art without undue experimentation.

The anode 18 may have an average pore diameter of 25 nanometers (nm) to 1000 nm, 50 nm to 800 nm, or 100 nm to 500 nm. The porous anode 18 may also have a cell wall thickness (e.g., average thickness of the wall separating two adjacent pores) of 5 nm to 100 nm, 5 nm to 80 nm, 5 nm to 50 nm, or 5 nm to 20 nm. The average pore diameter and wall thickness may be determined by any suitable method, such as scanning electron microscopy, the details of which may be determined by one of skill in the art without undue experimentation.

The solid-state electrolyte (SSE) 14 may be an ionic conductor and an electronic insulator, and may include, for example, an organic solid electrolyte, an inorganic solid electrolyte, or a combination thereof. Examples of the organic solid electrolyte may include polyethylene oxide or a derivative thereof, a polypropylene oxide or a derivative thereof, a phosphoric acid ester polymer, poly (L-lysine), polyester sulfide, a polyvinyl alcohol, a polyvinylidene fluoride, and polymers containing ionic dissociation groups. The inorganic solid electrolyte may be an oxide-containing solid electrolyte or a sulfide-containing solid electrolyte. Examples of the oxide-containing solid electrolyte may include at least one of Li_{1+x+y}AlₓTi₂₋ₓSi_{y}P_{3-y}O₁₂ (where 0<x<2 and 0≤y<3), BaTiO₃, Pb(ZrₐTi₁₋ₐ)O₃ (PZT) (where 0≤a<1), Pb₁₋ₓLaₓZr_{1-y}Ti_{y}O₃ (PLZT) (where 0≤x<1 and 0≤y<1), Pb(Mg_{1/3}Nb_{2/3})O₃—PbTiO₃ (PMN-PT), HfO₂, SrTiO₂, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (where 0<x<2 and 0<y<3), LiₓAl_{y}Ti_{z}(PO₄)₃ (where 0<x<2, 0<y<1, and 0<z<3), Li_{1+x+y}(AlₐGa₁₋ₐ)ₓ(Ti_{b}Ge_{1-b})₂₋ₓSi_{y}P_{3-y}O₁₂ (where 0≤x≤1, 0≤y≤1, 0≤a≤1, and 0≤b≤1), Li₂O, LiOH, Li₂CO₃, LiAlO₂, Li₂O—Al₂O₃—SiO₂—P₂O₅—TiO₂—GeO₂, or Li₃₊ₓLa₃M₂O₁₂ (where M is Te, Nb, or Zr, and 0≤x≤10). The oxide-containing solid electrolyte may be, for example, a garnet-type solid electrolyte, e.g., Li₇La₃Zr₂O₁₂ (LLZO) or Li₃₋ₓLa₃Zr₂₋ₐMₐO₁₂ (M-doped LLZO, where M is Ga, W, Nb, Ta, or Al, and 0≤x≤10 and 0≤a<2). A lithium super ionic conductor (LISICON) compound, e.g., Li₂₊₂ₓZn₁₋ₓGeO₄, wherein 0<x<1, may also be utilized to form the SSE.

In some embodiments, the solid-state electrolyte 14 may be, for example, a sulfide-containing solid electrolyte. Examples of the sulfide-containing solid electrolyte may include at least one of Li₂S—P₂S₅, Li₂S—P₂S₅—LiX (where X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂—P₂S₅—ZₘSₙ (where m and n each are a positive number, and Z represents any of Ge, Zn, and Ga), Li₂S—GeS₂, Li₂S—SiS₂—Li₃PO₄, Li₂S—SiS₂-LiₚMO_{q} (where p and q each are a positive number, M represents at least one of P, Si, Ge, B, Al, Ga, or In), Li₇₋ₓPS₆₋ₓClₓ (where 0≤x≤2), Li₇₋ₓPS₆₋ₓBrₓ (where 0≤x≤2), or Li₇₋ₓPS₆₋ₓIₓ (where 0≤x≤2). The sulfide-containing solid electrolyte may be prepared by melting and quenching starting materials (e.g., Li₂S or P₂S₅), or mechanical milling the starting materials. Subsequently, the resultant may be heat-treated. The sulfide-containing solid electrolyte may be amorphous or crystalline and may be a mixed form thereof.

The buffer layer 16 may be formed of a material that is both more electronic insulative and more ionic insulative than the solid-state electrolyte 14. In some embodiments, the buffer layer 16 may be formed of a buffer layer material with an electronic conductivity that is less than or equal to 1×10⁻² times, less than or equal to 0.5×10⁻² times, less than or equal to 0.1×10⁻² times an electronic conductivity of the solid-state electrolyte 14. In some embodiments, the buffer layer material may have an electronic conductivity that is greater than or equal to 1×10⁻⁸ times, greater than or equal to 1×10⁻⁷ times, or greater than or equal to 1×10⁻⁶ times an electronic conductivity of the solid-state electrolyte 14. In some embodiments, the electronic conductivity of the buffer layer material may be greater than or equal to 1×10⁻¹⁴ Siemens per meter (S/m), greater than or equal to 1×10⁻¹³ S/m, or greater than or equal to 1×10⁻¹² S/m, to less than or equal to 1×10⁻⁶ S/m, 1×10⁻⁷ S/m, or 1×10⁻⁸ S/m. In some embodiments, the buffer layer material may have an ionic conductivity that is less than or equal to 1×10⁻⁶ times, less than or equal to 0.5×10⁻⁶ times, less than or equal to 1×10⁻⁷ times, or less than or equal to 1×10⁻⁷ times an ionic conductivity of the solid-state electrolyte 14. In some embodiments, the buffer layer material may have an ionic conductivity that is greater than or equal to 1×10⁻¹⁴ times, greater than or equal to 1×10⁻¹² times, greater than or equal to 1×10⁻¹⁰ times, or greater than or equal to 1×10⁻⁸ times an ionic conductivity of the solid-state electrolyte 14. When the buffer layer material has the electronic conductivity and the ionic conductivity in the above described ranges, metal formation due to cation (e.g., Li⁺) reduction at the interface between the solid-state electrolyte 14 and the buffer layer 16 and at the interface between the anode 18 and the buffer layer 16 may be reduced or avoided. Therefore, separation between the solid-state electrolyte 14 and the anode 18 due to the deposition of metal at the interface may be avoided.

The buffer layer material may have a bandgap of greater than 3 electron-volts (eV), or greater than 4 eV, and may be thermodynamically stable against the porous anode, e.g., may be directly connected by a tie-line to lithium in the phase diagram and does not substantially support the transport of lithium ions.

The buffer layer material may include a binary compound, a ternary compound, a quaternary compound, or any combination thereof. In some embodiments, the buffer layer may include a buffer layer material represented by Formula (1)

MₘNₙZ_{z}HₕXₓ (1)

wherein M is Na, K, Rb, Cs, Al, or a metal of Group 2 or Group 3, or a combination thereof; m is 1, 2, 3, or 4; X is at least one halogen (e.g., F, Cl, Br, I, and/or At); x is 0, 1, 2, or 6; Z is 0, S, or a combination thereof; z is 0, 1, 2, 3, or 4; N represents nitrogen; n is 0, 1, or 2; H represents hydrogen; and h is 0, 1, 2, or 3, provided that x+z+n+h is at least 1. In one or more embodiments, Z is 0, and z is 1, 2, 3 or 4. In one or more embodiments, the buffer layer material is an oxide of Na, K, Rb, Cs, Al, a metal of Group 2, and/or a metal of Group 3.

As used herein, the term “Group” means a group of the Periodic Table of the Elements according to the International Union of Pure and Applied Chemistry (“IUPAC”) Group 1-18 group classification system. The Group 3 metal may include any suitable lanthanide or actinide, e.g., an element having an atomic number from 58 to 71, or 90 to 103.

In some embodiments, M in Formula (1) may be K, Rb, Cs, Be, Ca, Sr, Ba, Sc, Y, Th, Al, Lu, Tm, Er, Ho, Dy, Tb, Sm, Nd, Pr, La, Yb, La, or Yb.

Non-limiting specific examples of the buffer layer material may include BeO, SrF₂, KCl, CsCl, RbCl, SrBr₂, ThO₂, CsBr, RbBr, Y₂O₃, AlN, Lu₂O₃, Tm₂O₃, Ba₄I₆O, Er₂O₃, Ho₂O₃, Dy₂O₃, Tb₂O₃, CsI, KI, Sm₂O₃, Sm₂O₂S, RbI, Nd₂O₃, Pr₂O₃, CaO, La₂O₃, YbO, BaI₂, Be₃N₂, La₂SO₂, YbF₂, CaH₂, SrBe₃O₄, and/or Pr₂SO₂.

The buffer layer 16 may have any suitable thickness. In some embodiments, the buffer layer 16 may have a thickness of 5 nm to 500 nm, 5 nm to 100 nm, 20 nm to 50 nm, or 25 nm to 35 nm.

Further details of a solid-state battery may be found in U.S. Patent Publication No. 2022/0052374, the content of which is incorporated herein as reference in its entirety.

The buffer layer 16 may be disposed in a configuration to preserve the porosity of the anode 18 so that metal (such as lithium), a reduction product of the cation from the cathode (such as Li⁺), may be deposited within the pores of the porous anode 18. In some embodiments, the buffer layer 16 may be on the outer surface 18-2 of the cell walls 18-1 of the anode 18 facing the solid-state electrolyte 14. In some embodiments, the buffer layer 16 may completely cover (100%) or cover only a portion of the outer surface 18-2 of the cell walls 18-1 of the anode 18, e.g., 90% to 99%, 80% to 95%, or 60% to 85%, based on a total surface area of the outer surface 18-2 of the cell walls of the anode 18.

In some embodiments, the buffer layer 16 conforms to the morphology of the outer surface 18-2 of the cell walls 18-1 and may have a porous structure similar to that of the anode 18. That is, the buffer layer material does not completely cover the openings 18-6 of the pores 18-5 of the anode 18. In some embodiments, the buffer layer material is deposited only on the cell walls 18-1, e.g., on the outer surface 18-2 of the cell walls 18-1, and forms pores 16-5 exposing the underlying pores 18-5 of the anode 18. In some embodiments, the buffer layer exposes 50% or greater, 60% or greater, or 80% or greater of the openings 18-6 of the pores 18-5 adjacent to the buffer layer 16 in the anode 18, based on a total area of the openings 18-6 of the pores 18-5 adjacent to the buffer layer 16 in the anode 18.

In some embodiments, a ratio between the porosity of the buffer layer 16 and that of the anode 18 is 1.2:1 to 0.5:1, for example, 1.2:1 to 1:05:1. For example, the porosity of the buffer layer 16 may be 120%, 110%, 105%, 90%, 75%, or 50% of the porosity of the anode 18. In some embodiments, the porosity of the buffer layer 16 may be greater than the porosity of the anode 18. In this case, the buffer layer 16 does not completely cover all of the outer surface 18-2 of the anode 18 and exposes a portion of outer surface 18-2 of the anode 18. For example, the ratio between the porosity of the buffer layer 16 and that of the anode 18 may be 1.05:1 to 1.2:1. In some embodiments, the porosity of the buffer layer 16 may be 100% or less, or 95% or less of the of the porosity of the anode 18. In some embodiments, the buffer layer 16 may have a porosity of 40% to 98%, 55% to 90%, 60% to 75%, 62% to 72%, or 65% to 70%, based on a total volume of the buffer layer 16. The porosity may be determined by any suitable method, such as scanning electron microscopy. Additional details may be determined by one of skill in the art without undue experimentation.

The buffer layer 16 may have an average pore diameter of 25 nanometers (nm) to 1000 nm, 50 nm to 800 nm, or 100 nm to 500 nm. The average pore diameter may be determined by any suitable method, such as scanning electron microscopy, the details of which may be determined by one of skill in the art without undue experimentation.

In some embodiments, the buffer layer 16 forms a thin coating layer, e.g., 5 nm to 40 nm in thickness, over the cell walls 18-1 of the anode 18. The porosity of the anode 18 coated with the buffer layer 16 (e.g., the anode and the buffer layer together) may be 30% or greater of the porosity of the anode 18 before the formation of the buffer layer 16. In some embodiments, the porosity of the anode 18 coated with the buffer layer 16 may be 30% or greater, 40% or greater, 50% or greater, 60% or greater, or 70% or greater of the porosity of the anode 18 before the formation of the buffer layer 16. In some embodiments, the porosity of the anode 18 coated with the buffer layer 16 may be 100% or less or 95% or less of the porosity of the anode 18 before the formation of the buffer layer 16.

Referring to FIG. 1, a portion of the solid-state electrolyte 14 may be directly exposed to the pores 18-5 of the porous anode 18 and in contact with the cell walls 18-1 around the pores 18-5 of the porous anode 18. However, embodiments of the present disclosure are not limited thereto, and in some embodiments, the solid-state electrolyte 14 may be in contact only with the outer surface 18-2 of the cell walls 18-1 and the buffer layer 16, and does not extend inside the pores of the anode 18.

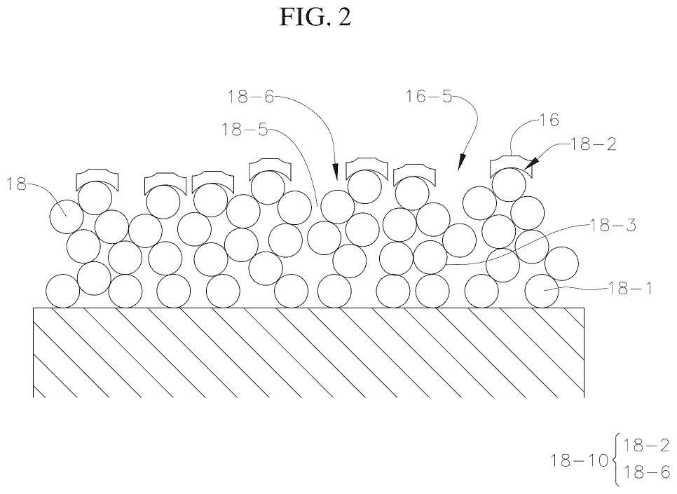

The porous anode 18 may have various suitable morphologies. FIG. 2 is a schematic illustrate of a porous anode 18 according to another embodiment of the present disclosure. Referring to FIG. 2, the anode 18 may include cell walls 18-1, pores 18-5 surrounded by inner surfaces 18-3 of the cell walls 18-1. The cell walls 18-1 may have an outer surface 18-2 surrounding pore openings 18-6. The outer surface 18-2 of the cell walls 18-1 and the pore openings 18-6 together forms the outer surface 18-10 of the porous anode 18. A buffer layer 16 may be deposited on the outer surface 18-2 of the anode 18. The buffer layer 16 may include pores 16-5 exposing pores 18-5 of the anode 18.

The buffer layer material may reduce or prevent precipitation of metal at the interface between the SSE and the porous anode. The metal deposition may be driven towards inside the pores of the porous anode, thereby compensating for any volume change caused by the metal deposition. Also, the buffer layer material may protect the interface between the SSE and the porous anode from any side reactions. Therefore, a solid-state battery according to embodiments of the present disclosure may lead to longer battery cycle life.

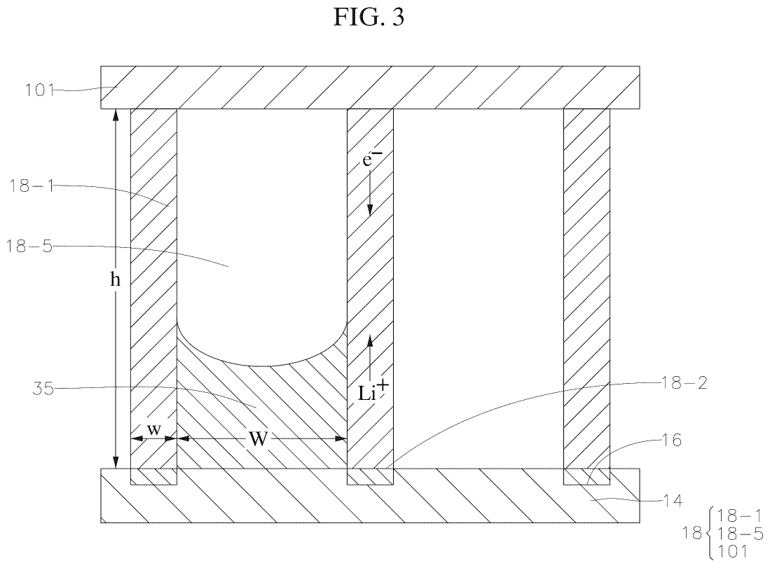

FIG. 3 is a schematic illustration of a porous anode solid-state electrolyte assembly with a buffer layer therebetween according to embodiments of the present disclosure. Referring to FIG. 3, the anode 18 includes cell walls 18-1, which are both electronic conductors and ionic conductors, and pores 18-5 defined by the inner surface of the cell walls 18-1. The cell walls 18-1 of the anode 18 may have a total thickness of h (e.g., 1 μm to 1000 μm), and each of the cell walls 18-1 may have a width w (e.g., 5 nm to 100 nm). The pores 18-5 may have a width W (or diameter, e.g., 25 nm to 1000 nm, or an average width or diameter of about 25 nm to about 500 nm). Furthermore, a material for forming the cell walls 18-1 of the anode 18 allows metal to easily slide along the walls of the cell walls 18-1. For example, the material for forming the cell walls 18-1 of the anode 18 may be lithiophilic to allow the lithium metal 35 to slide along the cell walls towards the current collector 101.

A buffer layer 16 is on the outer surface 18-2 of the cell walls 18-1 facing the solid-state electrolyte 14 (the SSE facing surface). The buffer layer 16 covers at least a portion of the SSE facing surface, e.g., 50%, 80%, 90%, or 99% or greater of the surface area of the SSE facing surface. The buffer layer 16 does not cover the inner surface of the cell walls 18-1 and exposes at least a portion of the inner surface of the cell walls 18-1. For example, the buffer layer 16 exposes 50%, 60%, 70%, or 80% or greater of the surface area of the inner surface of the cell walls 18-1. During charging and discharging cycles, metal ions (e.g., Li⁺) may pass through the solid-state electrolyte and get reduced to metal 35 (e.g., Li) inside the pores 18-5, but not at the interface between the buffer layer 16 and the anode 18 because the buffer layer material is an ionic insulator that can prevent metal ions from penetrating through the buffer layer 16 to be in contact with the anode 18. Furthermore, due to the electronic insulator characteristics, the buffer layer 16 further prevents electrons from the anode 18 to penetrate through the buffer layer 16 to come in contact with the metal ions at the interface between the buffer layer 16 and the solid-state electrolyte 14. As such, metal deposition is controlled to be happening inside the pores 18-5 of the anode 18, and not at the interface where the anode 18 is in contact with the solid-stated electrolyte 14 through the buffer layer 16. Therefore, the contact between the anode 18 and the solid-stated electrolyte 14 is maintained during charging-discharging cycles. In an embodiment, an inert vapor may further fill the pores 18-5.

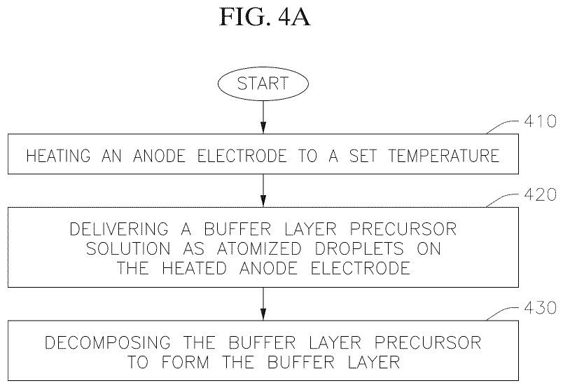

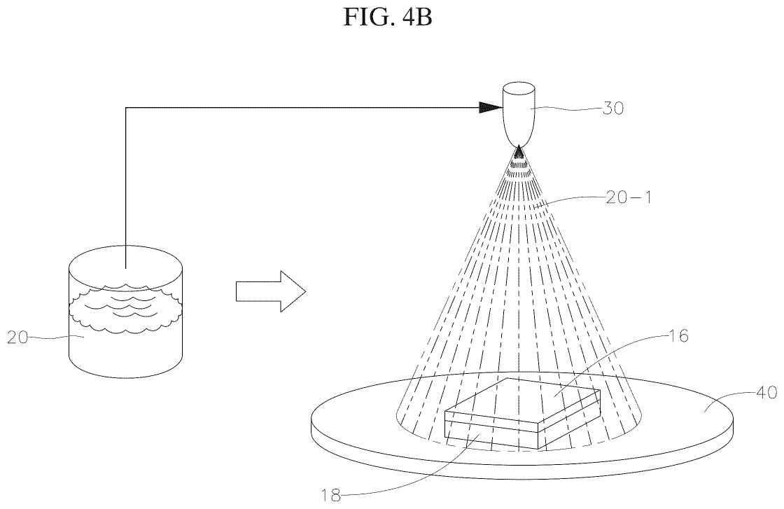

According to embodiments of the present disclosure, a buffer layer is formed on a porous anode utilizing spray pyrolysis. FIG. 4A is a flow chart illustrating a method of depositing the buffer layer utilizing spray pyrolysis and FIG. 4B is a schematic illustration of depositing the buffer layer utilizing spray pyrolysis. Referring to FIGS. 4A-4B, an anode electrode 18 is heated to a temperature of 250° C. or greater, and a buffer layer material precursor solution 20 is delivered as atomized droplets through a nozzle 30 onto the anode electrode 18. The buffer layer material precursor may be a salt of a metal, e.g., an alkali metal, Al, a Group 2 metal (e.g., an alkaline earth metal), a Group 3 metal (e.g., a lanthanoid metal, an actinoid metal, etc.), or any combination thereof. For example, the metal may include Na, K, Rb, Cs, Al, a metal of Group 2 or Group 3, or a combination thereof. In some embodiments, the salt may be a nitrate, a hydroxide, a sulfate, an oxalate, an acetate, a phosphate, a carbonate, a hydrozoic acid, a chloranilic acid, a trifuloromethane sulfonate, an isopropoxide, an oxide, and/or an acetylacetonate salt of the metal. By way of example, Table 1 lists some of the example precursors for depositing a lanthanum based buffer layer, and the decomposition temperature of some of them.

TABLE 1

| | Decom- |
|---|---|
| | position |
| | temperature |
| Name of the La salt | (° C.) |
| Lanthanum nitrate, La(NO₃)₃ | 300-570 |
| Lanthanum trifluoromethanesulfonate, | 600 |
| (CF₃SO₃)₃La | |
| Lanthanum hydroxide, La(OH)₃ | 330-490 |
| Lanthanum isopropoxide, C₉H₂₁LaO₃ | |
| Lanthanum sulfate, La₂(SO₄)₃ | >800 |
| Lanthanum oxalate, La₂(C₂O₄)₃ | >700 |
| Lanthanum acetate, La(CH₃CO₂)₃ | 334-700 |
| Tris(cyclopentadienyl) Lanthanum, La(C₅H₅)₃ | |
| Lanthanum phosphate, LaPO₄ | |
| Lanthanum acetylacetonate, La(C₅H₇O₂)₃ | |
| Lanthanum carbonate, La(CO₃)₃ | 700 |
| Chloranilic acid, C₁₈Cl₆La₂O₁₂ | |

In some embodiments, the buffer layer material precursor may be dissolved in a suitable solvent, such as water, an organic solvent, etc., to form a buffer layer material precursor solution. The buffer layer material precursor solution (e.g., salt precursors dissolved in an organic solvent) is supplied to the nozzle 30, e.g., a spray gun, and is deposited on the heated anode electrode 18 as a mist 20-1 with a droplet size in a range of about 1 nm to about 100 μm, for example, 10 nm to 20 μm, 10 nm to 900 nm, or 20 nm to 500 nm. In some embodiments, the droplets are about 50 nm to 200 nm in diameter. The size of the droplets may be suitably selected according to the morphology of the outer surface of the anode electrode 18, and/or the desired morphology of the buffer layer 16.

Upon contacting the heated anode electrode 18 (e.g., heated by a hot plate 40 and heated to, e.g., 280° C. to 330° C.), the solvent of the precursor solution is evaporated quickly (e.g., due to the small droplet size), and the solute goes through condensation, decomposition, reaction with other reactants (e.g., a reactive gas, e.g., O₂, etc.), and/or sintering. In some embodiments, the buffer layer material precursor is decomposed partially or completely by the heat of the anode electrode 18, and forms the buffer layer 16 including an oxide or salt-oxide of the metal on the anode electrode 18.

In some embodiments, the salt of the buffer layer material precursor may include a metal cation and an anion. The anion may include a non-metal element, such as N, F, S, O, C, P, Cl, etc. In some embodiments, the buffer layer formed through spray pyrolysis may include the metal and a small amount of the non-metal element from the precursor salt due to the decomposition process in spray pyrolysis, where a small amount of the precursor salt may not be completely decomposed. In some embodiments, the non-metal element may be included at about 0.1 atomic % (at %) to about 10 at % based on a total number of atoms in the buffer layer. In some embodiments, the non-metal element is about 1 at % to about 5 at % based on the total number of atoms in the buffer layer. In some embodiments, the buffer layer material (i.e., the product produced by the reaction of the precursor salt on the heated anode) may include the same elements as the non-metal element of the anion, and the amount of the non-metal element contributed from the incomplete decomposition of the precursor salt may be identified through data deconvolution.

In some embodiments, the anode electrode 18 may be heated through a hot plate to a temperature sufficiently high to cause decomposition of the buffer layer material precursor. In some embodiments, the anode electrode 18 may be heated to a temperature of 280° C. or greater, 300° C. or greater, or 350° C. or greater. In some embodiments, the anode electrode 18 may be heated to a temperature of 280° C. to 330° C. In some embodiments, no additional heat annealing is conducted after the deposition of the buffer layer 16. In some embodiments, an additional heat annealing may be further conducted after the deposition of the buffer layer 16.

In some embodiments, the amount of the buffer layer material precursor solution 20 delivered on the heated anode electrode may be adjusted according to the desired morphology of the buffer layer 16. In some embodiments, a target porosity value of the anode coated with the buffer layer is first set, the amount of the buffer layer material precursor solution 20 is then selected to create the buffer layer that provides the target porosity when coated on the heated anode electrode. For example, when an anode coated with a first buffer layer has a first porosity, and the same anode coated with a second buffer layer has a second porosity lower than the first porosity, a volume of the buffer layer material precursor solution utilized in forming the second buffer layer is more than a volume of the buffer layer material precursor solution utilized in forming the first buffer layer. In some embodiments, a concentration of the buffer layer material precursor solution utilized in forming the second buffer layer with a lower porosity is higher than a concentration of the buffer layer material precursor solution utilized in forming the first buffer layer with a higher porosity.

In some embodiments, a deposition mask may be placed between the nozzle 30 and the anode 18 to provide precise deposition of the buffer layer material precursor solution, thereby providing a buffer layer with a precisely controlled morphology (e.g., shape, thickness, distribution over the anode, etc.).

Through spray pyrolysis, the buffer layer material precursor in the form of fine droplets is quickly (e.g., within minutes or seconds, e.g., in less than 10 minutes, 5 minutes, or 1 minute) converted to the buffer layer material upon contacting the heated anode electrode 18, and forms a homogeneous or substantially homogeneous layer covering the outer surface of the porous anode electrode 18, without clogging the pores of the anode electrode 18. Due to the small droplet size, spray pyrolysis allows for precise control of the thickness, the porosity, the morphology, and the grain size of the buffer layer, which then enables the desirable stronger bonding between the solid-state electrolyte and the porous anode, prevention or reduction of the separation between the solid-state electrolyte and the porous anode, controlled deposition of metal ions inside the pores of the anode, improved battery lifespan, etc. Utilizing spray pyrolysis to deposit the buffer layer may be desirable also because it is easy to scale up to deposit on a large substrate (e.g., of the scale of 10 square centimeters or greater), and can be easily integrated into the existing battery manufacturing process, thereby enabling large scale production of the solid-state batteries.

In contrast, when forming the buffer layer utilizing a related art dip coating method, the porous anode would be dipped into a precursor solution, pulled out, and heated to form the buffer layer. In this case, both sides of the anode may be coated with the precursor material including on the side not in contact with the solid-state electrolyte undesirably, the thickness uniformity of the buffer layer may be influenced by gravity, it may be harder to control the final thickness of the buffer layer, and the precursor solution may soak into the pores of the anode and when dried, may cover the wall (e.g., inner wall) of the pores with the buffer layer material, which may then make it difficult to control the metal deposition during charging and discharging to be inside the pores. Furthermore, to control the shape of the buffer layer utilizing dip coating, substrate masking may be needed, which is more difficult than the usage of a deposition mask.

When another related art method, spin coating is utilized, the precursor solution is first dispensed onto a spinning anode, then the coated anode is heated to form the buffer layer. In this case, it may be harder to control the final thickness of the buffer layer, and the precursor solution may be drawn into the pores of the anode by gravitational force during the spinning and when dried, may cover the wall (e.g., inner wall) of the pores with the buffer layer material, which may then make it difficult to control the metal deposition during charging and discharging to be inside the pores. Due to the need for spinning the substrate, this method is further limited in the sample size by the size of the rotating stage size. Furthermore, to control the shape of the buffer layer utilizing spin coating, substrate masking may be needed, which is more difficult than the usage of a deposition mask.

Also, when depositing the buffer layer utilizing inkjet printing, the precursor solution needs to be formulated to have a viscosity that is suitable for the inkjet printing by selecting the solvent and concentration. Once deposited onto the anode, the sample is then dried and heated to form the buffer layer. To realize fast drying, the solvent selection for inkjet printing is limited to more volatile ones. Due to the separate dispensing step and heating step, the precursor solution sits longer on the anode, which may allow the precursor solution to soak into the pores of the anode, and when dried, may cover the wall (e.g., inner wall) of the pores with the buffer layer material, which may then make it difficult to control the metal deposition during charging and discharging to be inside the pores. Furthermore, the buffer layer thickness deposited through inkjet printing may be too thin to function as intended, and may therefore requires multiple deposition steps to achieve a desirable thickness.

In addition, depositing the buffer layer utilizing spray pyrolysis is also more desirable than other synthesized ceramics via pellet pressing of powders (e.g., from Pechini or solid state synthesis), any vacuum based processing or regular sol-gel process, due to the ease of morphology control, integration in the full device manufacturing process, scalability, etc.

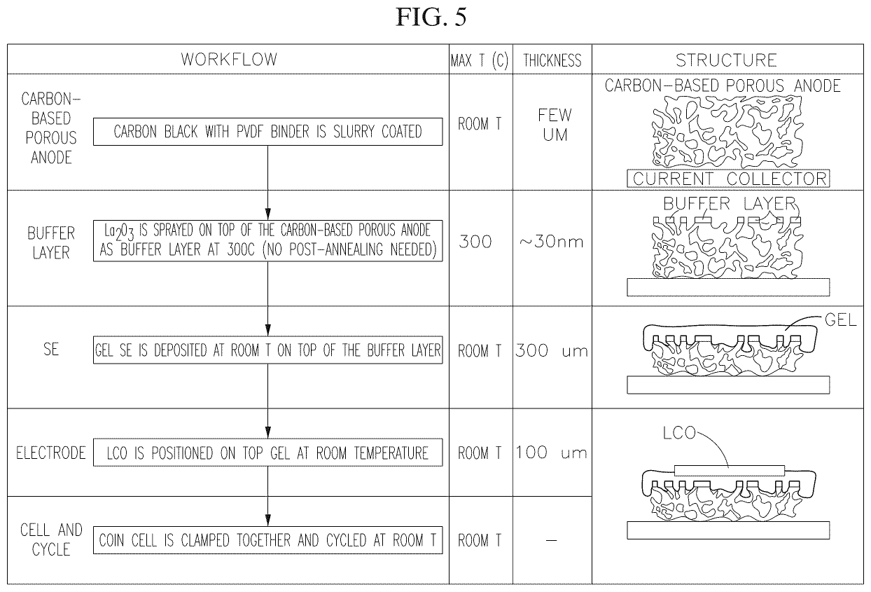

According to some embodiments, a porous anode electrode is first formed through a suitable method, such as solution coating, CVD, etc. A buffer layer is then deposited over the anode utilizing spray pyrolysis. Next, a gel solid electrolyte is deposited on the buffer layer. A cathode is then positioned on the gel solid electrolyte, and the stack is clamped together to form a coin cell. The cell may then be charged and discharged. FIG. 5 is a schematic illustration of a process of forming a solid-state battery according to embodiments of the present disclosure. Referring to FIG. 5, an anode may be first formed, e.g., through slurry coating of a carbon black solution including PVDF binder to form a carbon-based porous anode. The carbon-based porous anode may have any suitable thickness, e.g., 5 μm. A La₂O₃ buffer layer may then be formed on the carbon-based anode from a La(NO₃)₃ precursor solution utilizing spray pyrolysis. During the spray pyrolysis, the anode may be heated to about 300° C. to decompose the precursor solution La(NO₃)₃ to form the La₂O₃ buffer layer of about 30 nm in thickness. A gel solid electrolyte (SE) of about 300 μm in thickness may be deposited on the buffer layer, followed by placing a lithium cobalt oxide (LCO) cathode of about 100 μm in thickness over the gel solid electrolyte. The cell manufacturing may be completed by clamping the stack from the anode to the cathode. The battery cell can then be subjected to charging and discharging cycles. Except for the spray pyrolysis, the other processes in forming the battery may be conducted at any suitable temperature, such as room temperature.

Hereinafter, materials and solid-state batteries according to embodiments will be described in more detail with reference to the following examples and comparative examples.

### EXAMPLES

### Example 1

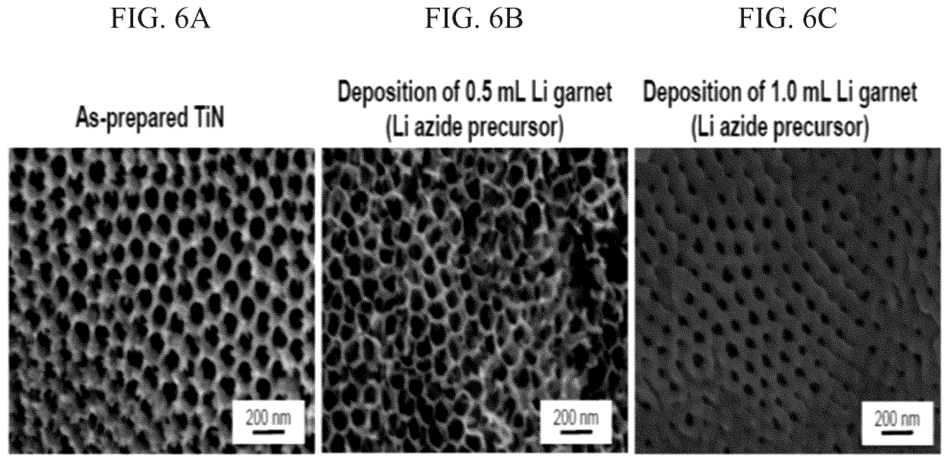

A titanium nitride (TiN) porous anode with a honeycomb nanostructure shown in FIG. 6A, a scanning electron microscope (SEM) image, was heated to a temperature of 315° C. utilizing a hot plate. The honeycomb structure has a wall thickness of about 10 nm and a distance between walls (pore diameter) of about 100 nm. The anode has a thickness of about 20 μm.

0.01 M LLZO equivalent of lanthanum nitrate (La(NO₃)₃), zirconium acetylacetonate (Zr(C₅H₇O₂)₄), and aluminum nitrate (Al(NO₃)₃) were added to a mixed solvent of methanol, 1-methoxy-2-propanol and bis(2-ethylhexyl) phthalate mixed at a volume ratio of 1:1:1 to prepare a first precursor solution. 0.01 M LLZO equivalent with 75% over-lithiation of lithium azide (Li₃N) was added to a mixed solvent of methanol, 1-methoxy-2-propanol and diethylene glycol monobutyl ether mixed at a volume ratio of 1:1:1 to prepare a second precursor solution. The first and second precursor solutions were mixed via a T connection to form a Li garnet precursor and spray deposited on the TiN porous anode utilizing DeVilbiss AG361 Automatic Spray Gun. Li garnet was thereby formed on the TiN porous anode. FIG. 6B shows an SEM image of the TiN porous anode coated with 0.5 mL Li garnet, and FIG. 6C shows an SEM image of the TiN porous anode coated with 1.0 mL Li garnet. No additional annealing was conducted on the deposited buffer layer. As can be observed from FIGS. 6A-6C, with 0.5 mL precursor solution, the buffer layer has substantially the same morphology has the anode layer, while with 1.0 mL precursor solution, the outer surface of the cell walls of the anode is covered with a uniform buffer layer, which has a porous morphology similar to that of the anode. It is confirmed that pray pyrolysis allows for precise control of the thickness and morphology (e.g., homogeneity, porosity) of the buffer layer, and preserves the porosity of the porous anode as desired.

### Example 2

Carbon powders with an average diameter of about 40 nm were utilized to form a 15-20 μm thick carbon based porous substrate with a porosity of about 60%. The carbon based porous substrate was utilized as the porous anode and heated to a temperature of 315° C. utilizing a hot plate.

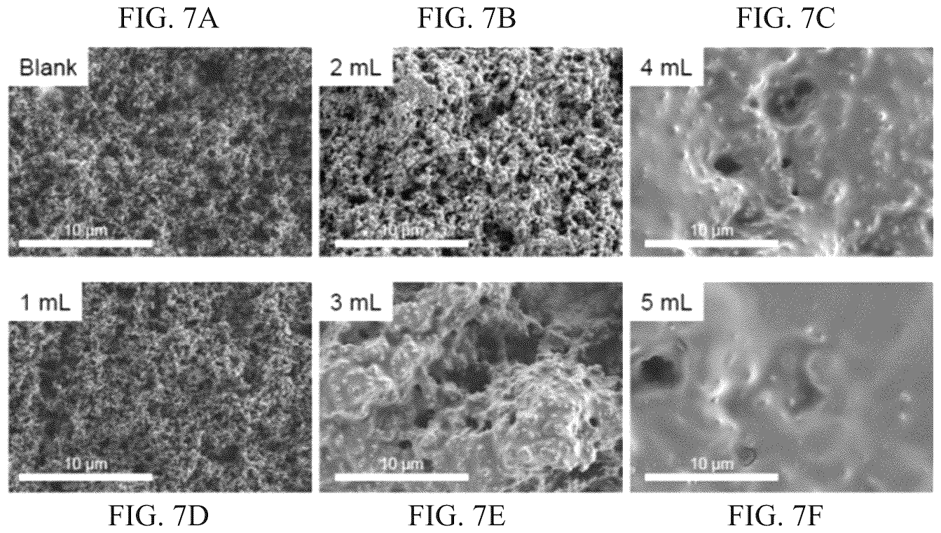

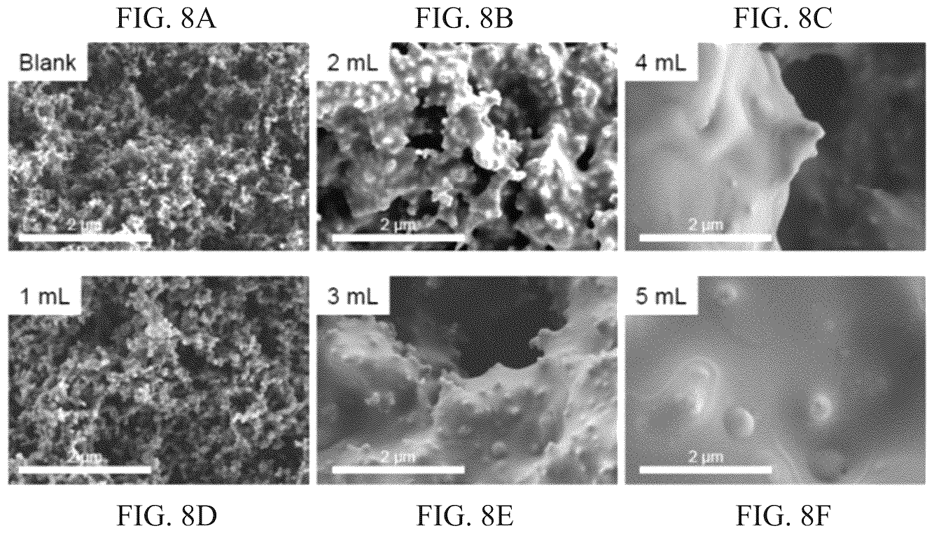

A precursor solution of 0.03 M La(NO₃)₃ in a mixed solvent of methanol, 1-methoxy-2-propanol, and bis(2-ethylhexyl) phthalate mixed at a volume ratio of 1:1:1 was spray deposited on the carbon based porous substrate utilizing DeVilbiss AG361 Automatic Spray Gun at a rate of 1 mL/h. La₂O₃ buffer layer was thereby formed on the carbon based porous substrate. FIGS. 7A-7F are SEM images at 5 k magnification showing the carbon based porous substrate, and the substrate coated with 1 mL, 2 mL, 3 mL, 4 mL and 5 mL of the precursor solution, respectively. FIGS. 8A-8F are SEM images at 25 k magnification of the same set of samples. As can be seen from FIGS. 7A-8F, 1 mL and 2 mL precursor solutions formed a coating layer on the substrate and simultaneously preserved the porosity of the substrate. 3 mL precursor solutions covered the openings of some small pores adjacent to the buffer layer but still have large pores in the anode open. However, 4 mL and 5 mL precursor solution significantly covered the openings of the pores adjacent to the buffer layer though the coated substrate still has a porosity greater than 0%.

As evidenced by Examples 1-2, a buffer layer deposited utilizing spray pyrolysis can have desirable thickness and morphology through controlling the amount of the precursor solution. The thickness and morphology may be further controlled through the size of the atomized droplets, the rate of the deposition, the concentration of the precursor solution, etc.

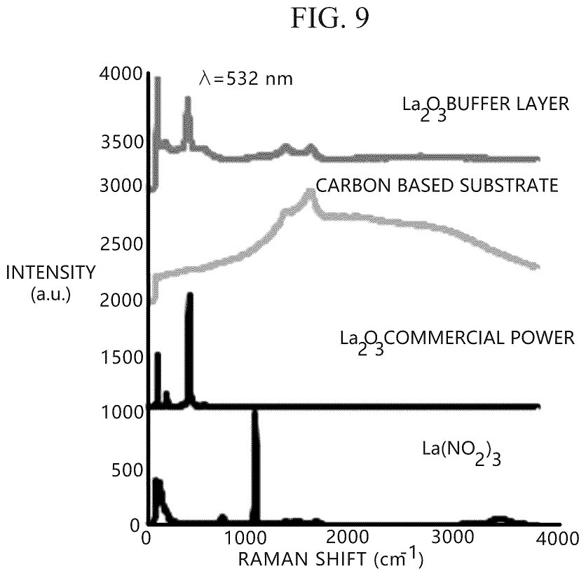

The buffer layer coated anode of Example 2, formed utilizing 2 mL of the precursor solution, was characterized utilizing Raman spectroscopy. FIG. 9 shows the Raman spectrum of the La₂O₃ buffer layer coated on the carbon based substrate, the carbon based substrate, commercial La₂O₃ powder, and the La(NO₃)₃ precursor. As can be seen from FIG. 9, the Raman spectrum of the buffer layer deposited on the carbon based substrate utilizing spray pyrolysis shows peaks corresponding to the peaks of the La₂O₃ powder as the main peaks with higher intensity, indicating the formation of La₂O₃ as the main component of the buffer layer. The Raman spectrum of the buffer layer also shows minor peaks corresponding to the underneath carbon-based substrate and/or carbon in the atmosphere at lower intensities. The correspondence of the Raman spectrum of the buffer layer and that of the carbon-based substrate are compared below in Table 2 between 1000 to 2000 cm⁻¹.

TABLE 2
Raman Shift (cm⁻¹)

| La₂O₃ deposited | carbon-based |
|---|---|
| utilizing spray pyrolysis | porous anode |
| 1350 | 1358 |
| 1596 | 1590 |

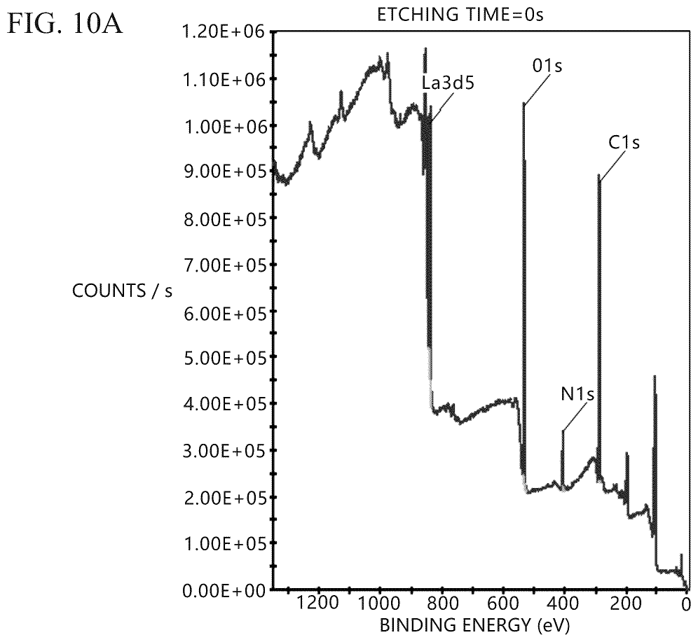

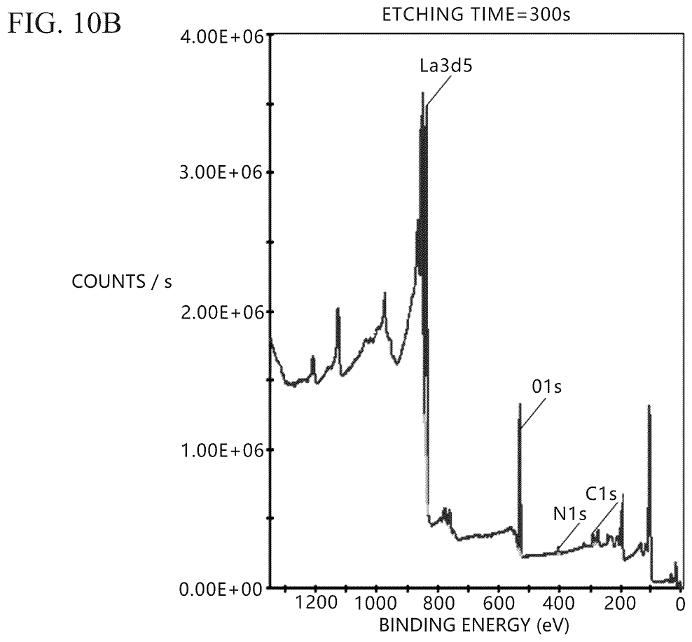

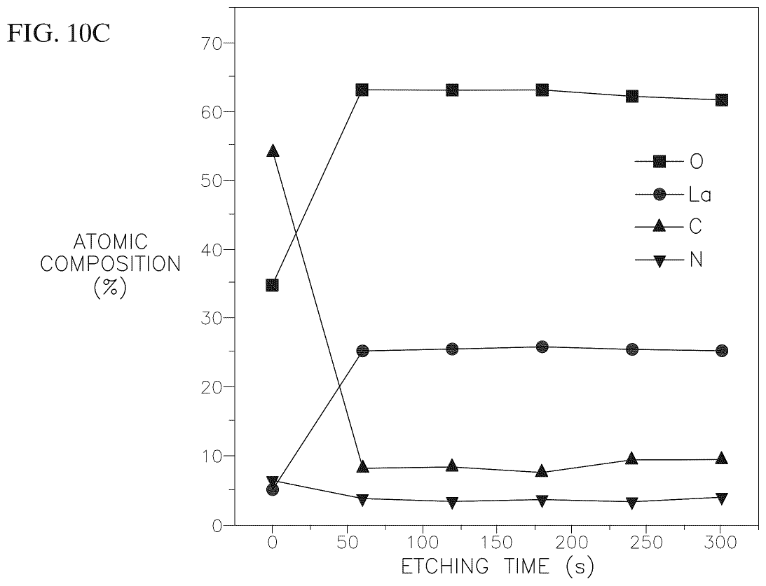

X-ray photoelectron spectroscopy (XPS) spectrum was collected at the surface of the buffer layer of Example 2, formed utilizing 2 mL of the precursor solution. The XPS was performed with Al K Alpha source gun with a spot size of 400 μm. Ar+ etching was then performed on the buffer layer with an ion energy of 4000 eV in monatomic mode for 300 s. All data was acquired with an energy step size of 1.0 eV for 5 scans. FIG. 10A shows the XPS spectrum of the buffer layer surface as deposited, FIG. 10B shows the XPS spectrum of the buffer layer surface after the buffer layer has been etched for 300 s, and FIG. 10C shows the overall depth profile of O, La, C and N in the buffer layer. As shown in FIG. 10A, the as deposited buffer layer surface (etching time=0 s) shows peaks corresponding to La, O, C, and N. Furthermore, as shown in FIG. 10B, these same peak are present on the etched buffer layer surface but with much reduced counts for 0, C, and N. Furthermore, as shown in FIG. 10C, as the etching time increases (indicating increased sampling depth from the surface of the buffer layer towards the carbon-based substrate), the amount of C reduces quickly and reaches a relatively stable amount, the amount of each of O and La increases quickly and reaches a relatively stable amount, and the amount of N reduces slightly and also reaches a relatively stable amount. The fast change in amount of 0, La and C in the first about 60 s of etching is likely due to environmental influences on the sample (extra carbon in the environment that got on the surface of the sample). The relatively stable amount of La at about 25 atomic % and the relatively stable amount of 0 at about 65 atomic % indicates the main compound of the buffer layer is La₂O₃. The about 3-4 atomic % of N in the buffer layer throughout the thickness range indicates that the precursor La(NO₃)₃ is not completely decomposed and there are residue amount of the precursor in the buffer layer deposited utilizing spray pyrolysis. In other words, existing residues of N in the buffer layer indicates and correlates with the fact that La(NO₃)₃ was utilized as the precursor for forming the buffer layer and spray pyrolysis was the deposition method.

### Example 3 Solid-State Battery

A slurry of carbon black mixed with polyvinylidene fluoride (PVDF) was coated on a Cu foil current collector and dried at ambient temperature (about 25° C.) to form a carbon-based porous anode (MIEC) about 5 μm in thickness. The anode was heated to 300° C. utilizing a hot plate, and La(NO₃)₃ precursor was deposited on the heated anode utilizing spray pyrolysis to form a La₂O₃ buffer layer (ELI) of about 30 nm in thickness. No post annealing was conducted. A gel solid electrolyte was prepared utilizing a solid poly(vinylidene fluoride-co-hexafluoropropylene) (PVDF-HFP) matrix, and lithium bis(pentafluoroethanesulfonyl)imide salt dissolved in a mixed solvent of ethylene carbonate and propylene carbonate (mixed in a weight ratio of 1:1) was added to the PVDF-HFP matrix. The gel solid electrolyte was deposited at ambient temperature (about 25° C.) on the buffer layer to form a solid-state electrolyte of about 300 μm in thickness. A LiCoO₂ (LCO) layer of about 100 μm was positioned over the solid-state electrolyte to form a cathode, and the whole stack was clamped together to form a coin cell.

### Comparative Example 1

A coin cell was formed utilizing a similar process as the coin cell of Example 3 except for not including the buffer layer. That is, the coin cell of Comparative Example 1 includes a carbon-based porous anode, a gel solid electrolyte and a LiCoO₂ cathode stacked and clamped together in the stated order.

### Impedance

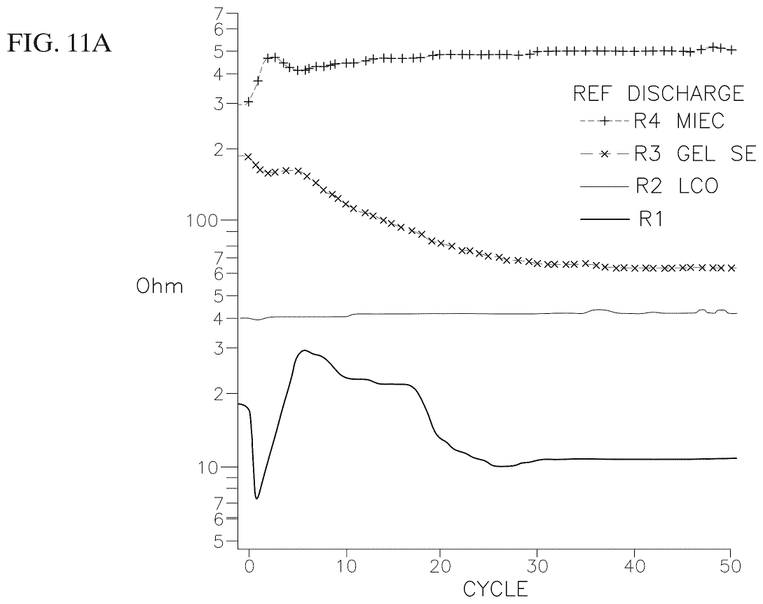

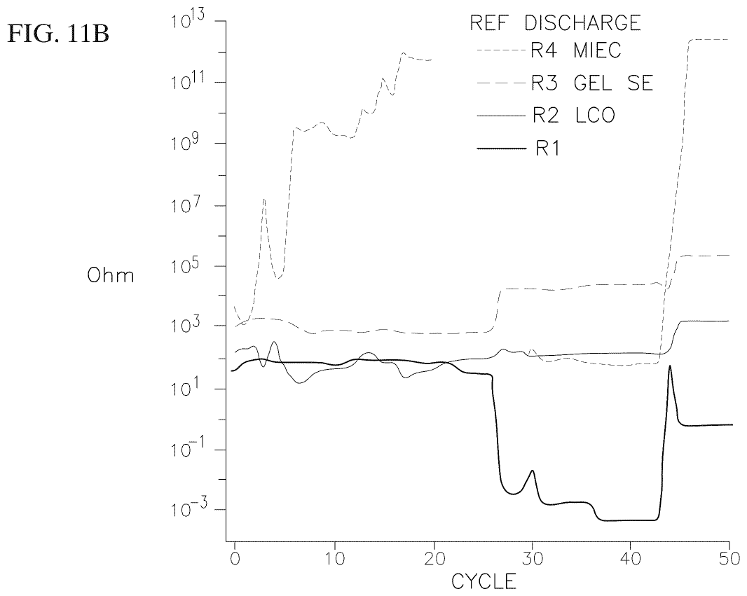

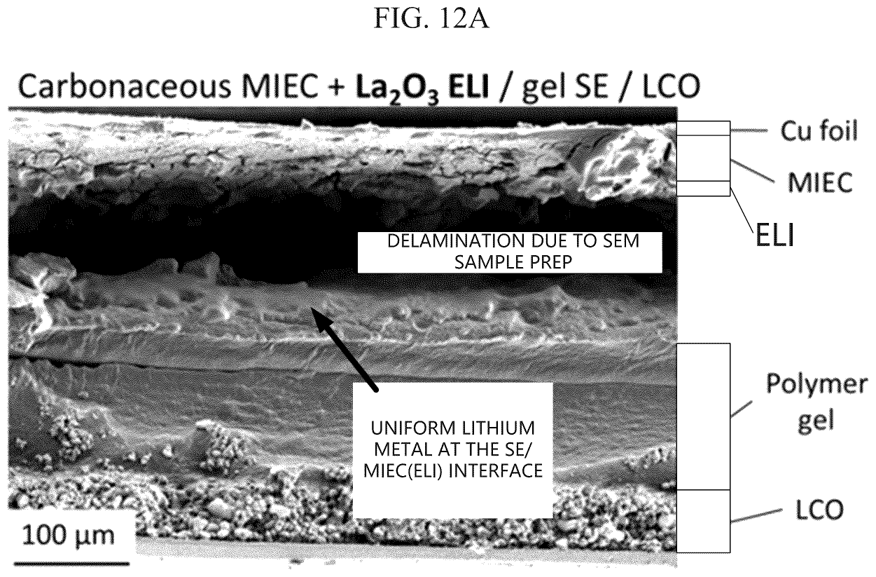

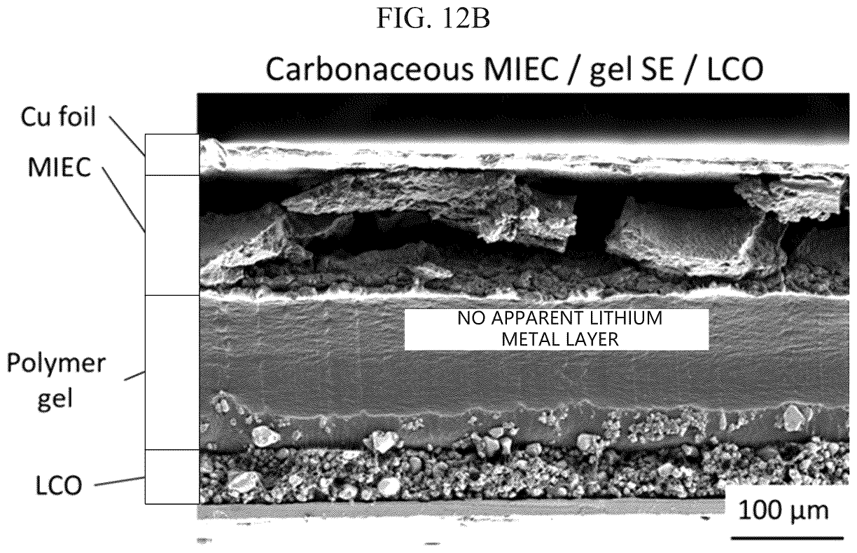

Each of the cells of Example 3 and Comparative Example 1 was subjected to charging and discharging cycles with charging conducted under constant current constant voltage (CCCV) mode at 0.5 C current until 4.3 V and discharging conducted under constant current (CC) mode at 0.5 C current. The impedance of each of the anode (R4), solid electrolyte (R3), cathode (R2) and the ohmic impedance of the whole cell (R1) was measured utilizing the MTZ-35 Impedance Analyzer from BioLogic Science Instruments. FIGS. 11A-11B show the change in impedance as a function of the number of charging-discharging cycles in the cells of Example 3 and Comparative Example 1 respectively, and FIGS. 12A-12B are each an SEM image of a cross-sectional view of the cell batteries after 50 cycles of the cells of Example 3 and Comparative Example 1 respectively.

As shown in FIG. 11A, the impedance of the anode of Example 3 reduces and reaches a plateau of about 65 ohm as the cycling continues. The impedance of the cathode of Example 3 goes up initially and then quickly reduces to a plateau of about 10 ohm as the cycling continues. The impedance of the solid-state electrolyte has a plateau value of about 50 ohm. The overall battery impedance is about 4-5 ohm.

Compared to Example 3, the impedance of Comparative Example 1 changes drastically, indicating the occurrence of separation between the anode and the solid-state electrolyte and instability of the cell structure. As shown in FIG. 11B, the impedance of the anode of Comparative Example 1 increases many orders of magnitude as the cycling started, going from about 103 ohm to about 1012 ohm within about 20 cycles, indicating separation between the anode and the solid-state electrolyte. The impedance of the anode was out of the range of the device between 20 to 30 cycles and back to the measurable range starting at 30th cycle, and then reached at about 1012 ohm at the end of 50th cycle. The impedance of the solid-sate electrolyte and the cathode were both significantly less stable and had larger magnitude of change during the cycling than those of Example 3, respectively. The overall battery impedance also mirrors the drastic changes observed in the impedance of the anode with larger scale changes in value as the cycling proceeds compared to that of Example 3.

From FIGS. 11A-11B, it can be observed that the overall impedance after 50 cycles is much lower for the battery cell including the buffer layer than the battery cell without the buffer layer. Without being bound by any particular theory, it is believed that the stable and lower impedance of the battery cell including the buffer layer is contributed by the improved bonding between the solid-state electrolyte and the anode through the buffer layer, which acts as an effective binder to reduce and prevent delamination between the solid-state electrolyte and the anode. Furthermore, due to the buffer layer, the contact between the solid-state electrolyte and the anode are better preserved. In addition, due to the nature of the buffer layer as an electronic insulator and an ionic insulation, deposition of metal, e.g., lithium in Example 3, is better controlled and directed to be inside the pores of the porous anode rather than at the interface between the solid-state electrolyte and the anode. Accordingly, the interface between the solid-state electrolyte and the anode is stably maintained via the buffer layer.

Referring to FIG. 12A, a substantially uniform layer of deposited lithium can be observed inside the pores of the anode, indicating that the buffer layer controls lithiation and guides lithium to deposit substantially uniformly inside the pores of the anode. The controlled deposition of lithium inside the pores of the porous anode also suggests that the contact between the solid-state electrolyte and the anode is better preserved without the deposited lithium at their interface.

In contrast, there is no apparent lithium metal layer in the cross-sectional view of the battery cell of Comparative Example 1 shown in FIG. 12B, indicating deposition of the lithium metal is most likely at the interface between the solid-state electrolyte and the anode, which then leads to the separation of the solid-state electrolyte and the anode, and the increased impedance and instability of the battery.

While this invention has been described in detail with particular references to example embodiments thereof, the example embodiments described herein are not intended to be exhaustive or to limit the scope of the disclosure to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims, and equivalents thereof.

What is claimed is:

1. A method of manufacturing an electrochemical cell, the method comprising:
spraying a precursor solution on an anode, the precursor solution comprising a metal salt dissolved in a solvent and the anode being at a temperature of 250° C. or greater;
reacting the metal salt on the anode to form a buffer layer; and
attaching a solid-state electrolyte to the buffer layer.

2. The method of claim 1, wherein the reacting of the metal salt comprises decomposing the metal salt and/or reacting the metal salt with a reactive gas.

3. The method of claim 1, wherein the anode is at a temperature of 280° C. to 330° C.

4. The method of claim 1, further comprising:
providing a set volume of the precursor solution to an atomizer.

5. The method of claim 1, wherein the buffer layer has a porosity of 40% to 98%, based on a total volume of the buffer layer.

6. The method of claim 1, wherein
the anode has a first porosity,
the buffer layer has a second porosity, and
a ratio between the second porosity and the first porosity is 1.2:1 to 0.5:1.

7. The method of claim 6, wherein the ratio between the second porosity and the first porosity is 1.05:1 to 1.2:1.

8. The method of claim 6, wherein the buffer layer is to expose 50% or greater of pores adjacent to the buffer layer in the anode, based on a total number of pores adjacent to the buffer layer in the anode.

9. The method of claim 1, wherein the buffer layer is about 5 nm to 500 nm in thickness.

10. The method of claim 1, wherein the buffer layer comprises a material represented by Formula (1):
MₘNₙZ_{z}HₕXₓ (1)
wherein in Formula (1),
M is Na, K, Rb, Cs, Al, a metal of Group 2 or Group 3, or a combination thereof;
m is 1, 2, 3, or 4;
X is at least one halogen;
x is 0, 1, 2, or 6;
Z is 0, S, or a combination thereof;
z is 0, 1, 2, 3, or 4;
N represents nitrogen;
n is 0, 1, or 2;
H represents hydrogen; and
h is 0, 1, 2, or 3,
provided that x+z+n+h is at least 1.

11. The method of claim 10, wherein Z is 0 and z is 1, 2, 3, or 4.

12. The method of claim 1, wherein the metal salt comprises a nitrate, a hydroxide, a sulfate, an oxalate, an acetate, a phosphate, a carbonate, a hydrozoic acid, a chloranilic acid, a trifuloromethane sulfonate, an isopropoxide, and/or an acetylacetonate salt of a metal.

13. The method of claim 1, wherein
the metal salt comprises a metal and an anion group comprising a non-metal element, and
the buffer layer comprises the metal and the non-metal element, and the non-metal element is about 0.01 atomic % (at %) to about 65 at % in amount based on a total number of atoms in the buffer layer.

14. The method of claim 13, wherein the non-metal element is about 0.1 at % to about 5 at % in amount based on the total number of atoms in the buffer layer.

15. The method of claim 13, wherein the non-metal element comprises N, F, Cl, I, Br, S, O, C, and/or P.

16. The method of claim 1, wherein the buffer layer comprises La₂O₃ and about 1 atomic 25% (at %) to about 5 at % of N.

17. An electrochemical cell, comprising:
an anode having a first porosity,
a buffer layer on the anode and having a second porosity, and
a solid-state electrolyte on the buffer layer,
wherein a ratio between the second porosity and the first porosity is 1.2:1 to 0.5:1.

18. The electrochemical cell of claim 17, wherein the ratio between the second porosity and the first porosity is 1.05:1 to 1.2:1.

19. The electrochemical cell of claim 17, wherein the buffer layer comprises a material represented by Formula (1):
MₘNₙZ_{z}HₕXₓ (1)
wherein in Formula 1,
M is Na, K, Rb, Cs, Al, a metal of Group 2 or Group 3, or a combination thereof;
m is 1, 2, 3, or 4;
X is at least one halogen;
x is 0, 1, 2, or 6;
Z is 0, S, or a combination thereof;
z is 0, 1, 2, 3, or 4;
N represents nitrogen;
n is 0, 1, or 2;
H represents hydrogen; and
h is 0, 1, 2, or 3,
provided that x+z+n+h is at least 1.

20. The electrochemical cell of claim 19, wherein Z is O and z is 1, 2, 3, or 4.
